(19) United States
(12) Patent Application Publication
(10) Pub. No.: US 2009/0308821 A1
(43) Pub. Date: Dec. 17, 2009

(54) METHOD OF DISPLAYING MERCHANDISE FOR RETAIL SALE

(75) Inventors: Claire Conley Brand, Lenexa, KS (US); Brian Russell Palmer, Kansas City, MO (US); John Richard Keeling, Kansas City, MO (US); Angela Canent, Overland Park, KS (US); Lauren Lane Beeman, Shawnee, KS (US); Curt A. Creason, Overland Park, KS (US); Michael D. Davids, Leawood, KS (US); Clinton G. Newton, Liberty, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HALLMARK CARDS, INCORPORATED, Kansas City, MO (US)

(21) Appl. No.: 12/491,227

(22) Filed: Jun. 24, 2009

(51) Int. Cl. A47F 7/00; G09F 7/00

(52) U.S. Cl. 211/45; 211/49.1; 40/584; 211/85.15

(57) ABSTRACT

A method of displaying merchandise which creates a more user friendly display that facilitates quicker and easier shopping for a consumer includes an arrangement of gift wrapping items in a section of a display fixture initially by size. The section includes a first display section for displaying items of a first average size, a second display section for displaying items of a second average size and a third display section for displaying items of a third average size. The display sections are adjacent one another and do not contain items that do not fall within the general size of the average display size. This arrangement by size quickly directs the consumer to a small subset of merchandise being displayed in a section that would meet the consumer's needs. A total number of price points may be reduced to at least partially correspond with the display sections. Sections may also be configured so that only items of a particular color and theme are displayed therein such that each section has an overall hue. Adjacent sections may then be configured to provide gradually darker hues. The consumer is then able to quickly narrow the search again by locating bags of an appropriate theme by the overall general color scheme of each section.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

The present invention relates to a method of displaying merchandise. More particularly, this invention relates to a method of displaying gift bags, tissue and related gift wrapping items for retail sale. The method is designed to readily convey information to gift wrap shopping consumers to more quickly direct the consumer to the appropriate wrapping items, thereby reducing shopping time and increasing the likelihood that the consumer finds the needed wrapping material for the specific gift and occasion for which they were shopping. Consumers often shop for gift wrapping products with a gift of a known dimension already in mind. In other words, they are often looking for wrapping items to wrap an already selected gift of a known size. In addition to knowing the size of the gift to be wrapped, consumers also shop with a specific event or gift theme in mind (e.g., a birthday for a young boy, a wedding gift, etc.). Accordingly, consumers want to find wrapping material of the proper size and theme as quickly as they can. This is often done by heading to “the gift wrap aisle” of a retail store. While there are often many choices available to the gift wrapping consumer in these aisles, the volume of choices and the arrangement of those choices do not help the consumer with the goal of quickly finding the right sized wrapping material of the appropriate theme.

One product that has grown in popularity over the years, primarily due to its convenience and ease in wrapping a gift, is gift bags. These bags now come in all shapes and sizes. They also come in any number of themes. The number of choices available, however, can frustrate consumers' efforts to find the right sized bag quickly.

Prior art displays of gift wrapping products, such as gift bags, primarily organized gift bags by theme. For example, all the gift bags with a birthday theme might be in one section. However, the consumer would often have to look through most of the bags of that section to find one of the proper size. FIG. 1 illustrates a gift wrap display of the prior art. The gift wrap is displayed on a fixture having a plurality of sections. In this arrangement, gift bags of all different sizes are spread out among each of the different sections and all throughout the entire display. Items, such as tissue paper, are displayed along a plurality of adjacent sections at approximately eye level. This arrangement forces consumers to look across the entire display as they are unsure if additional wrapping items of appropriate size or theme are available. Additionally, because objects of varying sizes and shapes are scattered throughout the display, consumers must look closely at each specific item to determine its price.

In one embodiment of the present invention, several of the sections are arranged to provide size specific display locations. The display locations then contain only gift wrap items of a similar size. In this manner, consumers can quickly ascertain that they need not look in other display locations with different sized wrapping materials.

In addition to clear size organization in each section of the display fixture, pricing has been greatly simplified and theme organization is readily ascertainable. In some of the prior art designs, such as in FIG. 1, adjacent items may have vastly different prices throughout an entire section, let alone across the entire display. To simplify this, the number of price points has been greatly reduced. Similarly, the sections have been divided by theme (e.g., birthday, wedding, etc.) and by color. To simplify the selection, the theme of each section can be readily identified by a display sign positioned above each section. Further, the gift wrapping items in each section may be generally related by color. For example, all of the items in one section may have a similar tone. Each section may then have an overall hue and adjoining sections may get progressively darker or brighter. This allows a consumer to quickly go towards a section that includes the type of color of gift wrapping item they desire, thereby likely eliminating the need to look through each of the individual sections. Once at the appropriate section, the size layout and organization readily allows the consumer to focus in on that portion of the fixture section that includes appropriately sized gift wrapping items.

To assist with the objects noted above, a method of displaying gift wrapping items has been developed that readily assists prospective purchasers with locating gift wrapping items of an appropriate size and theme. Additionally, a simplified pricing scheme has been developed to create an intuitive price grouping of products that is quickly understood by consumers.

Further objects, features and advantages of the present invention over the prior art will become apparent from the detailed description of the drawings which follows, when considered with the attached figures.

### BRIEF DESCRIPTION OF THE SEVERAL VIEWS OF THE DRAWINGS

The features of the invention noted above are explained in more detail with reference to the embodiments illustrated in the attached drawing figures, in which like reference numerals denote like elements, in which FIGS. 2-6 illustrate two possible embodiments of the present invention, and in which:

FIG. 1 is a front side-elevational schematic view of a merchandise display fixture configured to display gift wrap items in a prior arrangement;

FIG. 2 is a front side-elevational schematic view of a merchandise display fixture configured to display gift wrap items in accordance with an embodiment of the present invention;

FIG. 3 is an enlarged fragmentary view of the fixture of FIG. 2 taken in the area of 3;

FIG. 4 is a fragmentary perspective view of the fixture of FIG. 2;

FIG. 5 is an enlarged fragmentary view of the fixture of FIG. 4 taken in area of 5; and

FIG. 6 is an enlarged fragmentary view similar to that of FIG. 3, but configured to display gift wrap items in accordance with a second embodiment of the present invention.

### DETAILED DESCRIPTION OF THE INVENTION

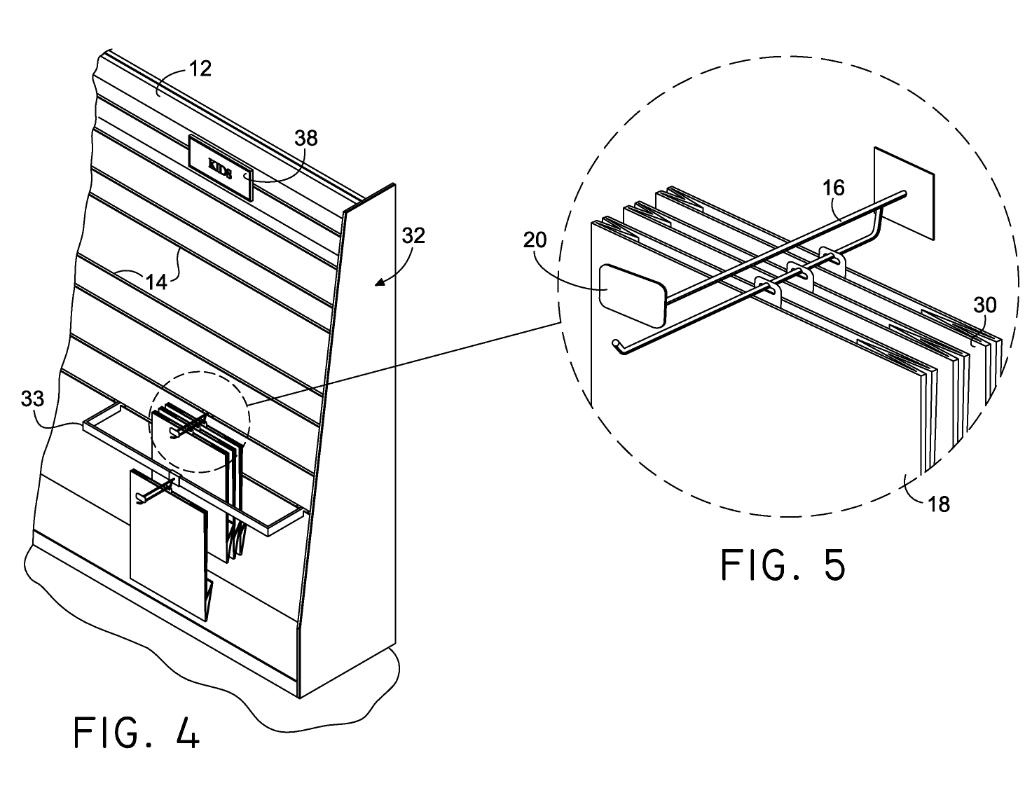

Referring now to the drawings in more detail and initially to FIG. 1, numeral 10 generally designates a merchandise display fixture arranged in accordance with a method of the prior art. The fixture 10 is generally divided into a plurality of sections 12. The sections 12 may be of an industry standard uniform dimension, such as, for example, 4 feet linear width sections. The fixture 10 includes a plurality of horizontal channels, grooves or tracks 14 (of the type illustrated in FIG. 4) into which a merchandiser may place any number of product display hooks 16 (of the type illustrated in FIG. 5). The hooks 16 extend outwardly from the fixture 10 and provide a location from which a merchandiser may hang products, such as gift wrapping items 18, for display. Often, each display hook 16 incorporates a product identification plate 20 onto which the merchandiser may place information about the product being displayed. Such information may include the product's bar code, its written description and its price information.

As can be seen from the prior art display fixture 10 in FIG. 1, each of the sections 12 lack a consistent organization, with a few minor exceptions. One exception is the running display across multiple sections of tissue paper 22. Similarly, wrapping paper 24, bows 26 and ribbons 28 appear to be grouped in one and a half sections. Gift bags 30, however, appear all across the sections and particular sizes of gift bags 30 are not found in any one particular location. Consequently, a user must look across the entire height of a section to be assured that the section does not contain any additional gift bags of the desired size. Further, the user must then perform the same task across multiple adjacent sections to be assured that a more appropriate gift bag is not available. Further, bags of different colors are placed adjacent each other in the same section. Consequently, bags of a desired color or theme may be present in multiple different sections, again forcing the consumer to look across a wide array of product to make a purchasing decision.

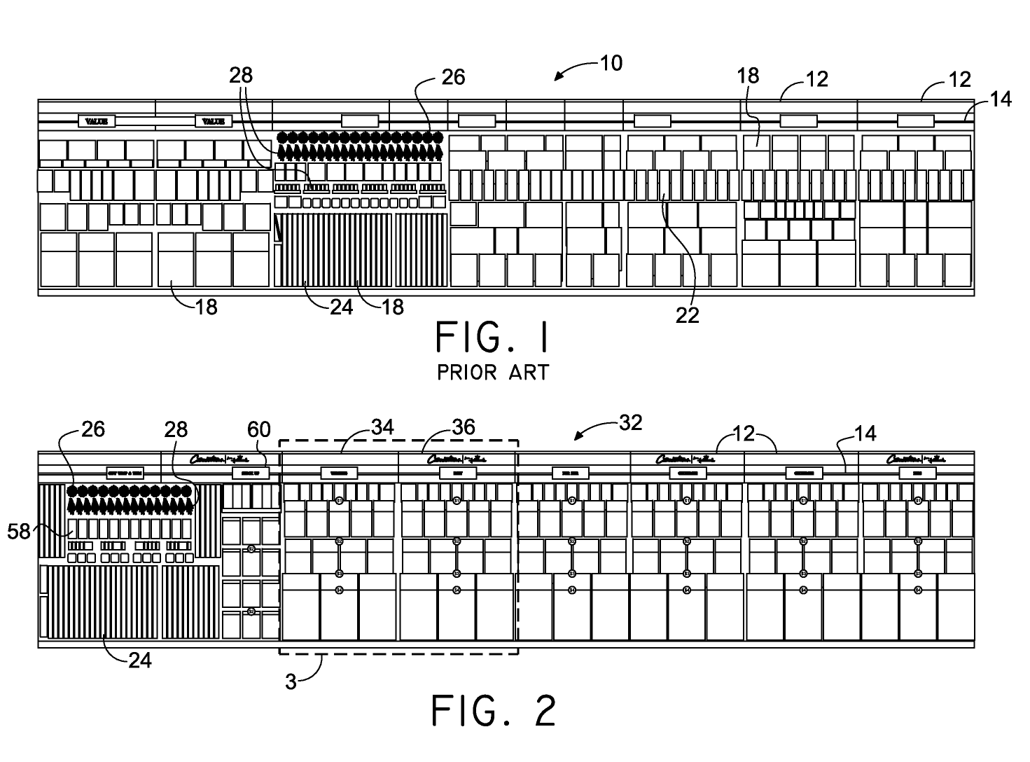

FIG. 2 illustrates a display fixture 32 arranged in accordance with an embodiment of the present invention. As before, the display fixture 32 is divided into a plurality of sections 12 which make use of horizontal tracks or grooves 14 to support product display hooks 16 and/or hanger bars 33. In this embodiment, however, the sections are preferably more identifiable and uniform in size and shape. It should be noted that while the gift wrapping items 18 are discussed as being displayed by way of display hooks 16 and/or hanger bars 33 supported in horizontal tracks 14, any number of prior art devices and methods for supporting merchandise from a display fixture are known and within the scope of the present invention. For example, some display fixtures make use of pegboards into which pegboard hooks may be positioned. Similarly, other types of display hooks may be used other than those discussed and/or illustrated herein. In short, any known method of hanging and/or supporting product for display can be used with and is within the scope of the present invention.

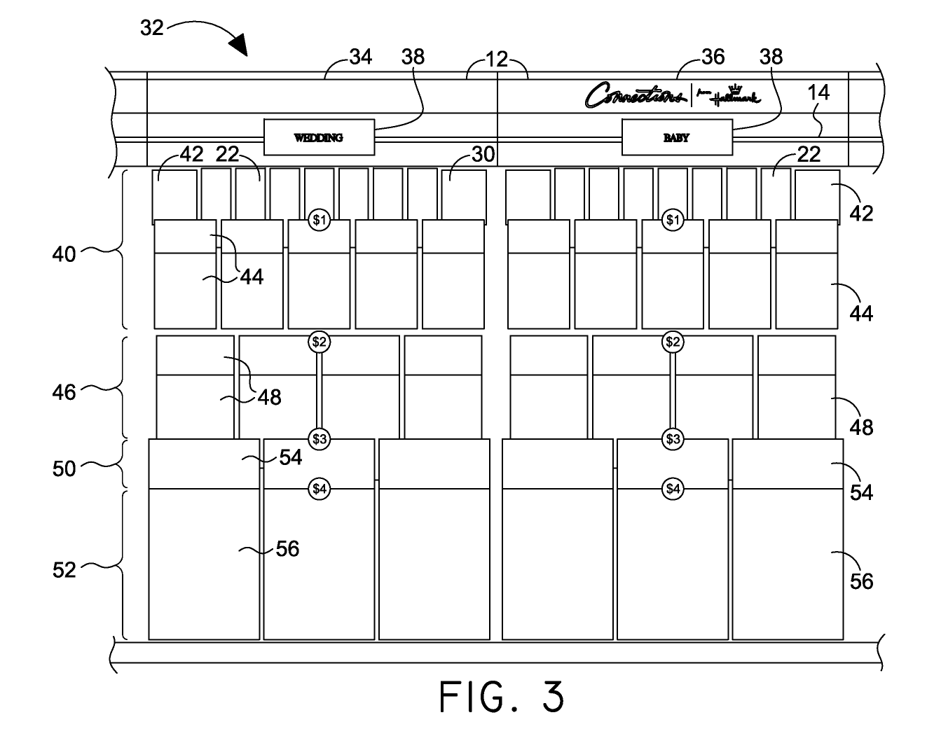

FIG. 3 illustrates an enlarged view of two sections 12 of the display fixture 32 of FIG. 2. For ease of discussions, these sections will be called a first section 34 and a second section 36. Each of the sections 12 preferably include a product category sign 38 positioned above the gift wrap items 18 displayed in the section 12. The product category sign 38 readily identifies through wording the event or theme to which the gift wrapping items 18 in that particular section 12 relate. Examples of such would be wedding, baby, kids, Christmas, Valentines, etc. This sign 38 can act as a first directional sign to get a consumer in front of the appropriate section 12 of the display fixture 32.

Below the product category sign 38 is a first display location 40. The first display location 40 is an area on the fixture section 12 in which gift wrapping items 18 of a first general size are displayed. In the present embodiment, the gift wrapping items displayed in the first display location 40 are the smallest gift wrapping items 18. These items may include packaged tissue paper 22, mini gift bags 42 and small gift bags 44. The gift wrapping items 18 that go in the first display location 40 are generally selected for inclusion in the first display location 40 by virtue of their size. As a result, all of the gift wrapping items 18 in the first display location are of generally the same size and therefore create an appearance of objects having a first average size. If a particular gift wrapping item 18 is larger than the average appearance of the other items in the first display location, it is moved to another display location. Excluding objects of larger sizes from the first display location 40 allows consumers to readily identify the location of gift wrapping items 18 of a particular size.

In addition to being related by virtue of the fact that the gift wrapping items 18 in the first display location 40 are all of generally the same size, the first embodiment of the present invention further envisions that all of the items in the first display location 40 are offered for sale at a single price. For example, and as illustrated in FIG. 3, all of the items 18 in the first display location 40 cost $1.00 each. This allows the consumer to avoid having to check the price of each individual item in a particular location as part of the consideration that goes into purchasing a product. As a result, consumers quickly know that all of the items 18 in the first display location 40 are of the same price and the consumer may then focus on the particular color or design of the gift wrapping item 18.

Each section 12 also preferably includes a second display location 46 into which gift wrapping items 18 of a second average size are displayed. In this illustrated embodiment, the items 18 displayed in the second display location 46 are gift bags 30 of a medium size. In the illustrated embodiment, the second display location 46 is positioned adjacent to and vertically below the first display location 40 such that the medium size gift bags 48 hang below the small gift bags 44. Further, the items 18 in the second display location 46 are, in this embodiment, offered for sale at a second price point. As illustrated in FIG. 3, the medium size gift bags are offered for sale for $2.00. Again, the pricing of all of the items in a particular display location at a single price speeds the decision process and eases the consumer's consideration requirements.

In this embodiment, each section 12 also includes a third display location 50 and a fourth display location 52. The third display location 50 contains items 18, such as large gift bags 54, of a third average size. Similarly, the fourth display location 52 contains items 18, such as jumbo gift bags 56, of a fourth average size. As before, the items in the third display location are preferably sold at a single price point and the items in the fourth display location are preferably sold at a single price point. In the illustrated embodiment, the items in the third display location 50 are all sold for $3.00 each while the items in the fourth display location 52 are sold for $4.00 each.

In addition to reducing the overall number of price points for the items 18 in a particular section 12, the limited number of price points that are selected can be organized by making the price points relate to one another. For example, all of the price points can be whole numbers or integer values. In that regard, and as illustrated in FIG. 3, the price points have been reduced to whole dollar values, namely, $1.00, $2.00, $3.00 and $4.00 dollars. This simplifies cost calculations for consumers. Further, the price points can be set to be related by being multiples of the lowest price point. As illustrated in FIG. 3, the price points for the second, third and fourth display locations, 46, 50, 52, are $2.00, $3.00 and $4.00, each of which are multiples of the $1.00 price point of the first display location 40. This arrangement can result in the use of a single price sign for each display location, thereby permitting the removal of the product ID plates 20 above each item 18 and the visual clutter they create.

In order to increase product density, some of the items 18 may be displayed in a manner where they overlap or cover a portion of the items in front of which they are positioned. This can be done by the use of hanger bars 33. For example, in the illustrated embodiment, portions of the large gift bags 54 in the third display location 50 are covered by the jumbo gift bags 56 in the fourth display location. If the partially covered items are of the same width as the uncovered items, as illustrated in FIG. 3, the consumer can readily surmise the size difference by virtue of the difference in sale price between the two display locations. Alternatively, the consumer may simply remove one of the items that is partially covered for inspection.

In addition to a particular section 12 readily conveying size, location, and cost information by virtue of the above-described arrangement of the items 18 displayed thereon, additional benefits are realized when adjacent sections also incorporate the described display arrangement. For example, as illustrated in FIG. 3, by using the same layout on both the first section 34 and the second section 36, a consumer looking for a small gift bag may move from one section 34 to another 36 and know right where to look for appropriately sized gift bags 30.

Further navigational and way finding advantages may be realized by the consumer as a result of implementing an organized color scheme approach. In that regard, in one embodiment, all of the gift wrapping items 18 in a particular section 12 are provided with a common overall color scheme. The result is that the items 18 in that section 12 cooperate to give the section 12 an overall color or hue. By then arranging the sections 12 such that the hues of each section 12 get progressively darker and/or brighter as a consumer moves in one direction, a consumer can quickly recognize where they would find items 18 of a particular color. For example, the items 18 in the first section 34 pertain to the same theme, which is identified in the product category side 38 as a wedding. Consequently, all of the items therein are of a light overall color. These items 18 make use of pastels and light colors, thereby creating an overall light colored hue for the first section 34.

Similarly, the items 18 in the second section 36 are identified by the product category sign 38 as being related to baby gifts. Consequently, the gift wrap items 18 therein make use of many pastels and light colors. However, the overall hue of the second section 36 is darker than the overall hue of the first section 34. This pattern of each next adjacent section 12 in a particular direction having an overall hue that is darker and/or brighter quickly conveys information to consumers as they approach the sections from the side. For example, if a consumer is shopping for a gift bag to wrap a wedding present, as they approach the gift wrap aisle, they can quickly see that the gift bags of a lighter overall appearance are at one end and can head there. They need not stop at the other end which includes items of bright primary colors.

To further emphasize the general hue of each section 12, the product category sign 38 of each section 12 can include a background color that matches the overall hue created by the color of the gift wrap items 18 in that section 12. For example, the background color of the wedding sign 38 could be an off white while the background color of the baby sign 38 of the second section 36 can be a light yellow. The signs 38 of the sections 12 to the far right side of the display fixture 32 illustrated in FIG. 2 could be bright red or bright blue and the gift wrapping items 18 displayed therein would primarily make use of corresponding primary colors. Further, the use of a corresponding color as the background color of a sign 38 can assist a consumer with locating the section 12 as they can recognize the color as they approach from the side before they can read the words on the sign 38.

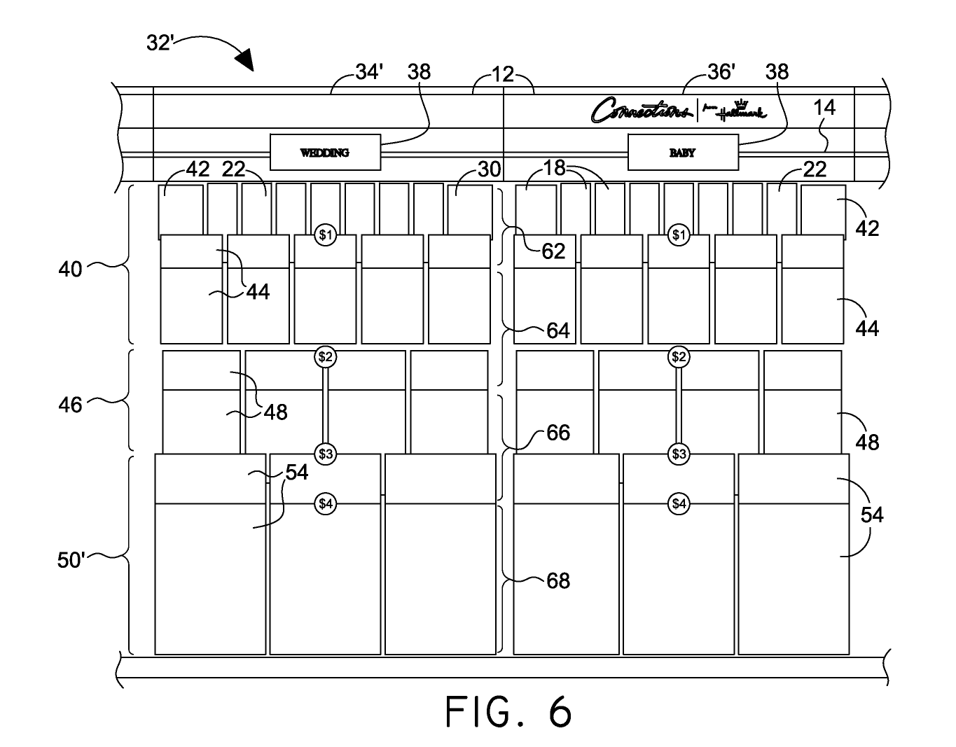

FIG. 6 illustrates a portion of a display fixture 32′ arranged in accordance with a second embodiment of the present invention. In this embodiment, the first and second sections 34′, 36′ still have the gift wrapping items 18 arranged initially according to size. In that regard, the gift wrapping items 18 are displayed in increasing or ascending size from the top of the display fixture 32′ to the bottom of the display fixture 32′. Additionally, each section 12 still has a first display location 40, for displaying gift wrapping items 18 of a first average size, a second display location 46, for displaying gift wrapping items 18 of a second average size, and a third display location 50′, for displaying gift wrapping items 18 of a third average size. The price point groupings, however, are different in the second embodiment.

In the initial embodiment discussed above, all of the items in each display location were sold at a single price point. While this arrangement simplifies pricing, it does so based almost solely on size. This does not allow other factors, such as manufacturing cost or retail value, to be considered in determining the price for a particular gift wrapping item 18. In other words, two gift wrapping items of similar size may have significantly different manufacturing costs or may have significantly different value to a consumer. For example, a medium sized gift bag 48 of a single solid color may cost less to manufacture or have less perceived value to a consumer than a medium sized gift bag 48 with a design or pattern and a more ornate handle. Consequently, the second embodiment accounts for these issues by at least partially untying the price point from the display location.

As illustrated in FIG. 6, the second embodiment has a first price point area 62, a second price point area 64, a third price point area 66, and a fourth price point area 68. As with the first embodiment, each section includes two rows of small bags 44 that are overlapped and two rows of medium sized bags 48 that are overlapped. However, in the second embodiment, the row of jumbo bags 56 has been replaced with a second row of large bags 54 that overlap the first row of large bags 54.

The first price point area 62 includes the mini bags 42 and the tissue paper 22 of the top row, as well as the top row of the small bags 44. The bags in the top row of small bags 44 can all be of a simple design, such as a single solid color and/or a two color pattern (e.g., stripes, polka dots, etc.). The bottom row of small bags 44 includes bags of a more complicated design (e.g., full color designs) and are thereby moved into the next price point area 64. Accordingly, in the illustrated second embodiment, simple small bags 44 are $1.00 and more ornate small bags 44 are $2.00. This gives the consumer the option to pay a little more for a fancier bag or go with a simple bag of the desired size for less money, all the while being able to quickly locate a gift bag that will meet their needs.

Similarly, the second price point area 64 includes the bottom row of ornate small bags 44 and the top row of simple medium bags 48. The third price point area 66 includes the bottom row of ornate medium bags 48 and the top row of simple large bags 54. Finally, the fourth price point area 68 includes the bottom row of ornate large bags 54. This embodiment provides the way finding advantages of the first embodiment and flexibility in pricing options.

Other advantages are present in the present invention. For example, as can be seen in FIG. 2, a couple of the sections 12 can be arranged to display other gift wrapping items 18, such as rolls of wrapping paper 24, bows 26, ribbons 28, and stickers or gift trims 58. These sections can incorporate some of the organizational and way finding concepts employed across the other sections 12. For example, a single price point may be created and displayed for the wrapping paper 24. Similarly, a stock up section 60 may be provided to allow consumers to purchase gift wrap items 18 for yet to be determined events. These items 18 could include gift bags of a generic appearance and/or colors and wrapping paper of various different shades.

It should be noted that the display hooks 16 and hanger bars 33 are not present and the number of horizontal grooves or tracks 14 are reduced in schematic FIGS. 1-3 and 6 for clarity and to simplify the drawings. Similarly, the most of items 18 that would be hung on the fixture 32 in FIG. 4 have been removed for clarity.

Many variations can be made to the illustrated embodiment of the present invention without departing from the scope of the present invention. Such modifications are within the scope of the present invention. For example, the order of the display locations could be switched. While the illustrated embodiment puts the smaller items on top, such that from top to bottom the items go from smaller to larger, these can be reversed such that the smaller items are on bottom and the larger items are on top. Additionally, some of the concepts can be used without the other concepts. For example, the organizational and display arrangement for the sections can be employed without the use of the color scheme tool for making sections have an overall hue and adjacent sections being of a slightly lighter or darker hue. Further, while the sections 12 have been illustrated with four display locations, any number of display locations could be used. Similarly, while the display locations have been illustrated as covering the full width of a fixture section, such is not required.

In certain circumstances, it may be necessary to locate items in a display location that do not fall in the same price point as all the other items. In this case, items placed therein could be divisions of the price point (e.g., 2 for $1.00 or 3 for $2.00). This helps to maintain the single price point concept, but also make it flexible to include other types of merchandise. Further, while the exemplary price points of $1.00, $2.00, $3.00, and $4.00 have been discussed, other price points are contemplated and within the scope of the present invention (e.g., $1.25, $2.25, $3.25, and $4.25, and other related price groupings). Other modifications would be within the scope of the present invention.

From the foregoing it will be seen that this invention is one well adapted to attain all ends and objects hereinabove set forth together with the other advantages which are obvious and which are inherent to the method and apparatus. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A method of displaying merchandise for retail sale on a display fixture, the method comprising:
displaying merchandise of a first size in a first display location;
displaying merchandise of a second size in a second display location, wherein the merchandise of the second size is larger than the merchandise of the first size, and wherein the first display location is above the second display location; and
displaying merchandise of a third size in a third display location, wherein the merchandise of the third size is larger than the merchandise of the second size, and wherein the second display location is above the third display location;
wherein the first display location does not include merchandise of either the second size or the third size, wherein the second display location does not include merchandise of either the first size or the third size, and wherein the third display location does not include merchandise of either the first size or the second size.

2. The method of claim 1, wherein the merchandise being displayed in the three display locations is selected from a group comprising: tissue paper, gift bags, bows and ribbons.

3. The method of claim 2, wherein each item of merchandise displayed in the first location is offered for sale at the same price, wherein the price of items in the first location is a first price, wherein each item of merchandise displayed in the second location is offered for sale at the same price, wherein the price of items in the second location are a second price, wherein each item of merchandise displayed in the third location is offered for sale at the same price, wherein the price of items in the third location is a first price, wherein third price is more than the second price, and wherein the second price is more than the first price.

4. The method of claim 3, wherein the second price and the third price are multiples of the first price.

5. The method of claim 3, wherein the first, second and third prices are integer values.

6. The method of claim 5, wherein the first price is one dollar, wherein the second price is two dollars, and wherein the third price is three dollars.

7. The method of claim 1, further comprising:
displaying merchandise of a fourth size in a fourth display location, wherein the merchandise of the fourth size is larger than the merchandise of the third size, and wherein the third display location is above the fourth display location;
wherein the fourth display location does not include merchandise of either the first size, the second size or the third size, and wherein the first, second and third display locations do not include merchandise of the fourth size.

8. The method of claim 1, wherein the display fixture includes at least first, second and third sections of uniform width, wherein each section includes its own first, second and third display locations, wherein the first and second sections abut each other, wherein the second and third sections abut each other, wherein the merchandise displayed in the first section is of a generally uniform group of colors which define a first hue, wherein the merchandise displayed in the second section is of a generally uniform group of colors which define a second hue, wherein the merchandise displayed in the third section is of a generally uniform group of colors which define a third hue, wherein the second hue is generally darker than the first hue, and wherein the third hue is generally darker than the second hue.

9. The method of claim 8, wherein at least the first, second and third sections each include a sign above their respective first display locations that convey information about the merchandise in that particular section and wherein each sign includes a background color that corresponds with the hue of that section.

10. The method of claim 1, wherein merchandise from one display location is at least partially overlapped by merchandise from an adjacent display location, whereby the merchandise is in a layered appearance.

11. A method of displaying gift bags for retail sale on a display fixture, wherein the display fixture includes sections of uniform width, the method comprising:
displaying gift bags of first average size in a first display location adjacent an upper portion of a first section of the display fixture;
displaying gift bags of second average size in a second display location of the first section of the display fixture, wherein the second display location is adjacent and below the first display location; and
displaying gift bags of third average size in a third display location of the first section of the display fixture, wherein the third display location is adjacent and below the second display location;
wherein the first average size of the gift bags in the first display location is smaller than the second average size of the gift bags in the second display location, wherein the second average size of the gift bags in the second display location is smaller than the third average size of the gift bags in the third display location; and
wherein the display fixture includes at least first, second and third sections, wherein each of the first, second and third sections have first, second and third display locations, wherein the first section is adjacent the second section, wherein the second section is adjacent the third section, and wherein the first, second and third display locations of adjacent sections align horizontally.

12. The method of claim 11, wherein the first display location does not include gift bags of a size equal to or greater than the second average size, wherein the second display location does not include gift bags equal to or smaller than the first average size or equal to or greater than the third average size, and wherein the third display location does not include gift bags of a size equal to or smaller than the second average size.

13. The method of claim 12, further comprising:
displaying gift bags of fourth average size in a fourth display location of the first section of the display fixture, wherein the fourth display location is adjacent and below the third display location, and wherein the gift bags in the fourth display location are larger than the gift bags in the third display location.

14. The method of claim 11, wherein each of the gift bags displayed in the first location are offered for sale at the same first price, wherein each of the gift bags displayed in the second location are offered for sale at the same second price, wherein each of the gift bags displayed in the third location are offered for sale at the same third price, wherein the third price is more than the second price, and wherein the second price is more than the first price.

15. The method of claim 14, wherein the second price and the third price are multiples of the first price, and wherein the first, second and third prices are integer values.

16. The method of claim 11, wherein at least some of the gift bags from one display location are at least partially overlapped by gift bags from an adjacent display location, whereby the gift bags are in a layered appearance.

17. The method of claim 11, wherein the merchandise displayed in the first section is of a generally uniform group of colors which define a first hue, wherein the merchandise displayed in the second section is of a generally uniform group of colors which define a second hue, wherein the merchandise displayed in the third section is of a generally uniform group of colors which define a third hue, wherein the second hue is generally darker than the first hue, and wherein the third hue is generally darker than the second hue.

18. The method of claim 11, further comprising:
pricing the gift bags in certain areas with a single price point, wherein each of the gift bags displayed in a first price point area are offered for sale at a first price, wherein each of the gift bags displayed in a second price point area are offered for sale at a second price, and wherein each of the gift bags displayed in a third price point area are offered for sale at a third price, wherein the third price is more than the second price, and wherein the second price is more than the first price.

19. The method of claim 18, wherein the first price point area includes a portion of the gift bags displayed in the first display location, wherein the second price point area includes a portion of the gift bags displayed in the first display location and a portion of the gift bags displayed in the second display location, and wherein the third price point area includes a portion of the gift bags displayed in the second display location.

20. The method of claim 18, wherein corresponding display locations and price point areas are not coextensive.

21. The method of claim 18, wherein corresponding display locations and price point areas are coextensive.

22. A method of displaying gift bags for retail sale on a display fixture, wherein the display fixture includes sections of uniform width, the method comprising:
displaying gift bags of a first average size in a first display location adjacent an upper portion of a first section of the display fixture;
displaying gift bags of a second average size in a second display location of the first section of the display fixture, wherein the second display location is adjacent and below the first display location; and
displaying gift bags of a third average size in a third display location of the first section of the display fixture, wherein the third display location is adjacent and below the second display location;
wherein the first average size of the gift bags in the first display location is smaller than the second average size of the gift bags in the second display location, wherein the second average size of the gift bags in the second display location is smaller than the third average size of the gift bags in the third display location;
wherein the display fixture includes at least first, second and third sections, wherein each of the first, second and third sections have first, second and third display locations, wherein the first section is adjacent the second section, wherein the second section is adjacent the third section, and wherein the first, second and third display locations of adjacent sections align horizontally;
wherein the first display location does not include gift bags of a size equal to or greater than the second average size, wherein the second display location does not include gift bags equal to or smaller than the first average size or equal to or greater than the third average size, and wherein the third display location does not include gift bags of a size equal to or smaller than the second average size;
wherein at least a portion of the gift bags displayed in the first location are offered for sale at a first price, wherein at least a portion of the gift bags displayed in the second location are offered for sale at a second price, wherein at least a portion of the gift bags displayed in the third location are offered for sale at a third price, wherein the third price is more than the second price, and wherein the second price is more than the first price;
wherein the merchandise displayed in the first section is of a generally uniform group of colors which define a first hue, wherein the merchandise displayed in the second section is of a generally uniform group of colors which define a second hue, wherein the merchandise displayed in the third section is of a generally uniform group of colors which define a third hue, wherein the second hue is generally darker than the first hue, and wherein the third hue is generally darker than the second hue.

23. The method of claim 22, wherein the second price and the third price are multiples of the first price, and wherein the first, second and third prices are integer values.

24. The method of claim 23, wherein at least some of the gift bags from one display location are at least partially overlapped by gift bags from an adjacent display location, whereby the gift bags are in a layered appearance.

25. The method of claim 22, wherein each of the gift bags displayed in the first location are offered for sale at the same first price, wherein each of the gift bags displayed in the second location are offered for sale at the same second price, and wherein each of the gift bags displayed in the third location are offered for sale at the same third price.

26. The method of claim 22, wherein at least a portion of the gift bags displayed in the first location are offered for sale at the second price and wherein at least a portion of the gift bags displayed in the second location are offered for sale at the third price.

27. A display fixture for displaying gift bags for sale, the fixture comprising:
a first display location configured to display gift bags of a first average size;
a second display location configured to display gift bags of a second average size, wherein the second display location is adjacent and vertically aligned with the first display location; and
a third display location configured to display gift bags of a third average size, wherein the third display location is adjacent and vertically aligned with the second display location;
wherein the first average size of the gift bags in the first display location is smaller than the second average size of the gift bags in the second display location, wherein the second average size of the gift bags in the second display location is smaller than the third average size of the gift bags in the third display location;
wherein the first display location is not configured to display gift bags of a size equal to or greater than the second average size, wherein the second display location is not configured to display gift bags equal to or smaller than the first average size or equal to or greater than the third average size, and wherein the third display location is not configured to display gift bags of a size equal to or smaller than the second average size; and
wherein at least one of the display locations is sized such that at least some of the gift bags displayed therein would have to at least partially overlap gift bags displayed in an adjacent display location, whereby the gift bags would create a layered appearance.
